(19) United States
(12) Patent Application Publication
(10) Pub. No.: US 2005/0257647 A1
(43) Pub. Date: Nov. 24, 2005

(54) Pneumatic ratchet with forward/reverse actuator

(76) Inventor: David Baker, Fort Lawn, SC (US)

Correspondence Address: Schmeiser, Olsen & Watts LLP, 3 Lear Jet Lane, Suite 201, Latham, NY, 12110, US

(21) Appl. No.: 10/848,639

(22) Filed: May 19, 2004

(51) Int. Cl. B25B 13/46

(52) U.S. Cl. 81/57.39

(57) ABSTRACT

A pneumatic ratchet wrench that has a shift linkage system that allows the user to visually discern which direction the rotating anvil of the wrench will rotate without using the throttle. The shift linkage system is also configured conveniently so that the user can both use the wrench throttle and the linkage system via one hand. The shifting linkage, a linkage system, and method of shifting the rotational direction of the anvil is also disclosed.

### BACKGROUND OF THE INVENTION

1. Technical Field

The invention relates generally to a pneumatic ratchet with a forward/reverse actuator that allows for one-handed changes between forward and reverse rotations of the anvil.

2. Related Art

In the art of ratchets and pneumatic ratchets, there is a need for an improved pneumatic ratchet that offers easier rotational direction switching, and to allow for one handed operation.

### SUMMARY OF THE INVENTION

The present invention offers an improved pneumatic ratchet with a forward/reverse actuator that inter alia allows for one handed operation/direction switching.

In a first general aspect, the present invention provides a shifting linkage for switching the rotational direction of a rotating anvil of a pneumatic ratchet wrench, said shifting linkage comprising:
a first end functionally attached to a switch configured for user activation; and
a second end that operatively engages a ratchet and pawl system of said pneumatic ratchet wrench.

In a second general aspect, the present invention provides a system adapted for one handed rotational direction operation of a rotating anvil on a pneumatic ratchet comprising:
an elongate shift linkage that includes a first and a second end; and
an actuator that engages with said second end and further engages with a ratchet and pawl system of said ratchet, thereby causing change in rotational direction of said anvil upon activation of said first end.

In a third general aspect, the present invention provides a pneumatic ratchet wrench including a housing, a connector to an air source, a motor, a throttle, and a rotatable anvil, said tool further comprising:
a shift linkage system, wherein the shift linkage system is adapted to allow the user to visually discern the rotational direction of said anvil without an activation of said throttle; and
wherein said shift linkage system is further adapted to allow activation of said throttle and activation of said shift linkage system to be done by a user with the same hand.

In a fourth general aspect, the present invention provides a method for shifting the rotational direction of a rotating anvil of a pneumatic ratchet wrench, said method comprising:
providing a shifting linkage having a first end functionally attached to a switch configured for user activation, said linkage further having a second end that operatively engages a ratchet and pawl system of said pneumatic ratchet wrench; and
activating said switch, thereby causing said rotation direction of said rotating anvil to change.

The foregoing and other features and advantages of the invention will be apparent from the following more particular description of embodiments of the invention. It is to be understood that both the foregoing general description and the following detailed description are exemplary, but are not restrictive, of the invention.

### BRIEF DESCRIPTION OF THE DRAWINGS

Some of the embodiments of this invention will be described in detail, with reference to the following figures, wherein like designations denote like members, wherein:

FIG. 1 depicts a side sectional view of a pneumatic ratchet, in accordance with the present invention;

FIG. 2 depicts a top view of a pneumatic ratchet with partial removal, in accordance with the present invention;

FIG. 3. depicts a top view of a pneumatic ratchet with partial removal, with a shift linkage in a first and a second position, in accordance with the present invention;

FIG. 4A is a top, diagrammatic view of a pneumatic ratchet while an anvil is in the forward rotational direction, in accordance with the present invention; and

FIG. 4B is a top, diagrammatic view of a pneumatic ratchet while an anvil is in the reverse rotational direction, in accordance with the present invention.

### DETAILED DESCRIPTION OF THE INVENTION

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

The present invention offers a pneumatic ratchet with a forward/reverse actuator that inter alia allows for one handed reversal of rotational direction of an anvil, further wherein the user can visually discern the rotational direction of the anvil, concurrently while either engaging, or not engaging, the throttle. The present invention may further allow for the switching between forward and reverse rotational direction of the anvil with the concurrent engagement of the throttle without having to reposition the user's hand.

Thus, the present invention offers greater flexibility, greater ease of use, greater safety, and more options, than current pneumatic ratchets do. The term pneumatic ratchet as used herein denotes an air powered hand tool to be used in conjunction with at least one rotatable anvil.

The present invention provides for one handed operation of a pneumatic ratchet with the ability to change the direction of rotation of the anvil as well as the ability to discern the direction of rotation upon visual inspection of the position of the actuator mechanism with or without simultaneously engaging the throttle.

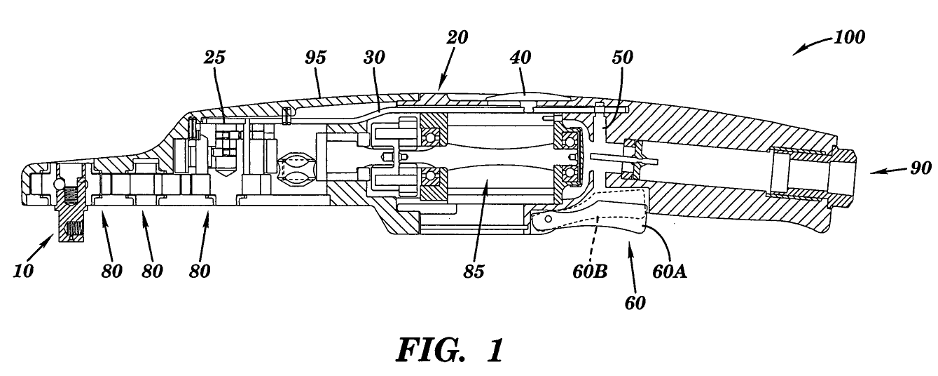

Referring to the drawings, FIG. 1 depicts a side sectional view of an embodiment of a pneumatic ratchet in accordance with the present invention. As depicted, a pneumatic ratchet wrench 100 has an outer housing 95, a connector 90 to an air source (e.g., air compressor) (not shown), a motor 85, a plurality of offset gears 80, a rotatable anvil 10, and a throttle 60 shown in an unengaged position 60A, and the throttle 60 shown in phantom in an engaged position 60B. A shift linkage system 20 is comprised of a forward-reverse switch 40 and a shift linkage 30. A forward-reverse actuator 25 operatively engages both with a portion of the shift linkage system 20 and the offset gears 80.

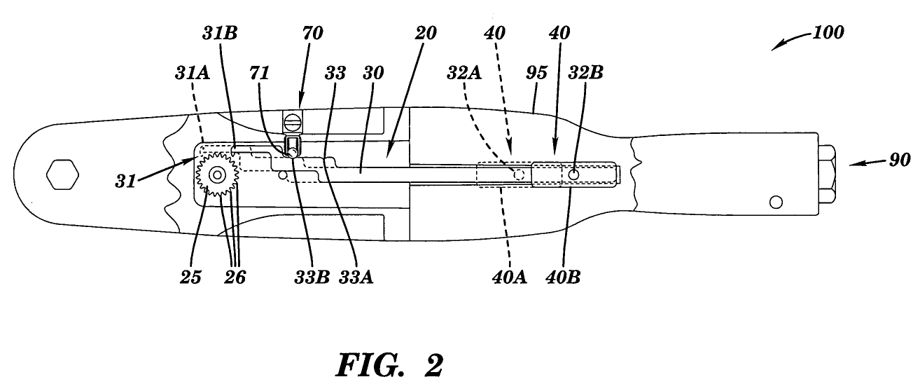

A throttle pin 50, acts as a safety mechanism, by not allowing for the throttle 60 to go into the engaged position 60B when the forward-reverse actuator switch 40 is in neither a first position 32A or a second position 32B (see FIG. 2). This is because engagement of the throttle 60B when the switch 40 is not properly placed may cause damage to the tool 100.

FIG. 2 depicts a top view of an embodiment of the pneumatic ratchet 100 with partial removal of the housing 95 to facilitate viewing of aspects of the invention. The pneumatic ratchet wrench 100 has an outer housing 95, a connector 90 to an air source, such as an air compressor (not shown), a shift linkage system 20, a forward -reverse actuator 25, and an anvil 10.

The shift linkage system 20 includes an elongate shift linkage 30. At one end of the shift linkage 30 is an engagement end 31, while at the second end is a forward-reverse switch 40. Also located on the shift linkage 30 are a pair of detents 33 (i.e., a first detent 33A and a second detent 33B) which allow for the engagement of a spring-biased ball 71 with the shift linkage 30. The shift linkage 30 has two general positions. In a first position, which is shown in phantom, the switch 40, is slid forward to a first position 40A (shown in phantom); the engagement end 31 is a first position 31A; and, the ball 71 is engaged with a first detent 33A. Conversely, the shift linkage 30 has a second position (shown in solid). In the second position, the switch 40 is slid backwards to a second position 40B; the engagement end 31 is in the second position 31B; and, the ball 71 is engaged with the second detent 33B.

Thus, the sliding of the switch 40 from its first position 40A to its second position 40B causes the engagement end 31 to move from its first position 31A to its second position 31B, between which the engagement end 31 engages, and rotates the actuator 25 via its teeth 26. Similarly, the sliding of the switch 40 from its second position 40B to its first position 40A causes the engagement end 31 to move from its second position 31B to its first position 31A, between which the engagement end 31 engages, and rotates the actuator 25 via its teeth 26. Depending on which of the two positions that the switch 40 is moved from, will result in rotation of the actuator 25 in a opposite rotational directions.

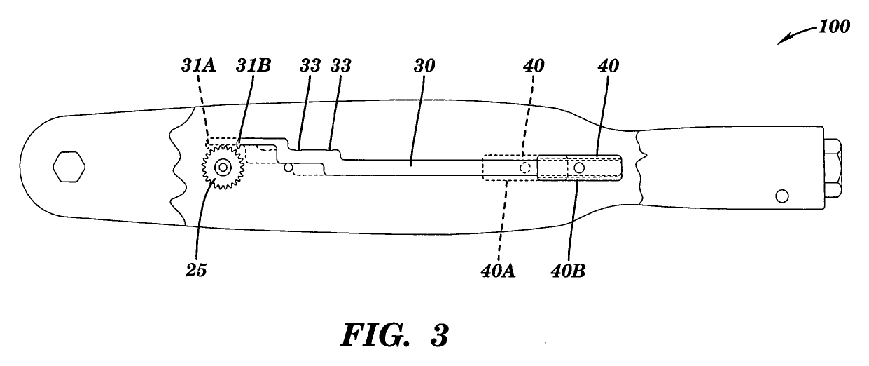

FIG. 3. depicts a similar view as in FIG. 2, but with more portions of the tool 100 removed for clarity's sake. As can be seen, the engagement end 31 is shown in a first position 31A (in phantom) and in a second position 31B. Correspondingly, the forward-reverse switch 40 is shown in phantom in the first position 40A and in the second position 40B.

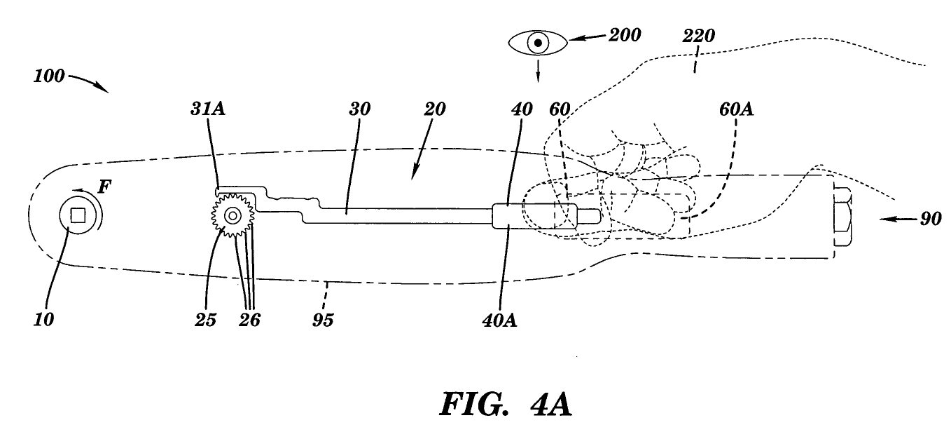

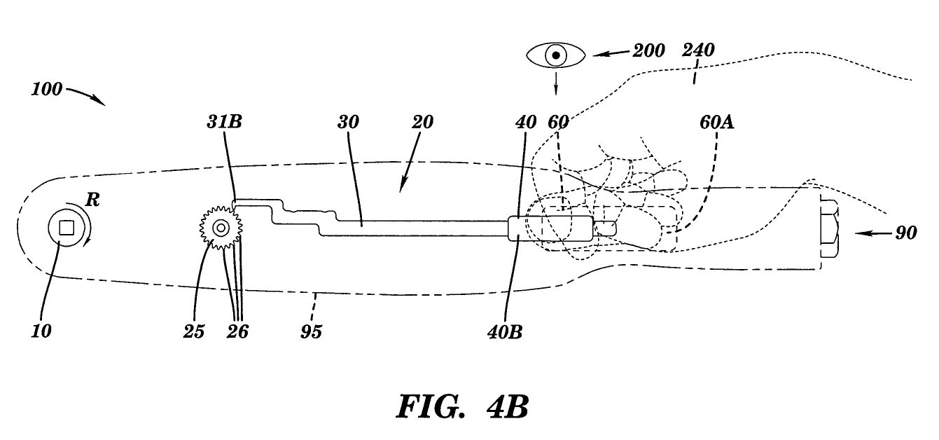

FIGS. 4A and 4B show a top, schematic, or diagrammatic, view of the tool 100 with a users's hand 220 and eye 200 during the use thereof.

FIG. 4A shows the user's hand 220 holding an embodiment with the switch in the first position 40A where the user can visually ascertain from their eye 200 the forward rotational direction of the anvil 10 without engaging the throttle 60. The shift linkage system 20 is oriented with the switch 40 is in the first position 40A. When the switch 40 is moved from the second position 40B (See e.g., FIG. 4B) to the first position 40A, the switch 40 causes the shift linkage 30 to interact with the forward-reverse actuator 25 (via the engagement of the engagement end 31 with the teeth 26 of the actuator 25) which in turn acts upon a ratchet and pawl system to allow rotation motion of the anvil 10, in the forward (i.e., tightening) direction as denoted by directional arrow “F”. Thus, the user can visually discern 200 what the rotational direction of the anvil 10 will be with, or without, engaging the throttle 60. Further, the invention allows for the ability to engage the throttle 60 (i.e., move throttle to position 60B as in FIG. 1) as well as change the rotational direction of the anvil 10 with only the use of one hand 220.

FIG. 4B is the same view as in FIG. 4A, but conversely, showing the user's hand 240 engaging the switch 40 in a second position 40B. Similarly, the user can see from the user eye 200 what rotational direction of the anvil 10 will be without engaging the throttle 60B. With the switch 40 in the second position 40B, the shift linkage system 20 is moved rearward along the tool 100 so that the engagement end 31 is the second position 31B. So, when the switch 40 is moved from the first position 40A (See FIG. 4A) to the second position 40B, the engagement end 31 interacts with the gear teeth 26 of the forward-reverse actuator 25 which in turn acts upon a ratchet and pawl system so that the rotational direction of the anvil 10 is switched to the reverse (i.e., loosening) direction, as depicted by directional arrow “R”.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

1. A shifting linkage for switching the rotational direction of a rotating anvil of a pneumatic ratchet wrench, said shifting linkage comprising:
a first end functionally attached to a switch configured for user activation; and
a second end that operatively engages a ratchet and pawl system of said pneumatic ratchet wrench.

2. The shifting linkage of claim 1 wherein said linkage is elongate.

3. The shifting linkage of claim 1 further wherein the shifting linkage includes a plurality of detents.

4. The shifting linkage of claim 1, further comprising an actuator.

5. The shifting linkage of claim 4, wherein said actuator includes a plurality of gear teeth for engagement with said second end.

6. The shifting linkage of claim 4, wherein said actuator switches the direction of engagement of said ratch and pawl system.

7. The shifting linkage of claim 1 having a first position that causes the anvil to rotate in a forward rotational direction and a second position that causes the anvil to rotate in a reverse rotational direction.

8. The shifting linkage of claim 7, wherein a user can visually discern the rotational direction of said anvil without activation of a throttle of said wrench.

9. The shifting linkage of claim 1, wherein a user can operate a throttle of said wrench and activate said switch both with the same hand.

10. The shifting linkage of claim 7, further comprising a throttle pin adapted to prevent operating of a throttle when said linkage is neither in said first position or said second position.

11. A system adapted for one handed rotational direction operation of a rotating anvil on a pneumatic ratchet comprising:
an elongate shift linkage that includes a first and a second end; and
an actuator that engages with said second end and further engages with a ratchet and pawl system of said ratchet, thereby causing change in rotational direction of said anvil upon activation of said first end.

12. A pneumatic ratchet wrench including a housing, a connector to an air source, a motor, a throttle, and a rotatable anvil, said tool further comprising:
a shift linkage system, wherein the shift linkage system is adapted to allow the user to visually discern the rotational direction of said anvil without an activation of said throttle; and
wherein said shift linkage system is further adapted to allow activation of said throttle and activation of said shift linkage system to be done by a user with the same hand.

13. The tool of claim 12 wherein said rotatable anvil is driven by the motor via at least one offset gear.

14. A method for shifting the rotational direction of a rotating anvil of a pneumatic ratchet wrench, said method comprising:
providing a shifting linkage having a first end functionally attached to a switch configured for user activation, said linkage further having a second end that operatively engages a ratchet and pawl system of said pneumatic ratchet wrench; and
activating said switch, thereby causing said rotation direction of said rotating anvil to change.
